(19) United States
(12) Patent Application Publication
(10) Pub. No.: US 2002/0070181 A1
(43) Pub. Date: Jun. 13, 2002

(54) Filter assembly

(76) Inventors: Ivan J. Deanda, Houston, TX (US); Paul R. Ignaut, Houston, TX (US); Charles H. Flansburg, Andover, MN (US)

Correspondence Address: David B. Smith, Michael Best & Friedrich LLP, 100 East Wisconsin Avenue, Milwaukee, WI, 53202-4108, US

(21) Appl. No.: 09/736,080

(22) Filed: Dec. 13, 2000

(51) Int. Cl. B01D 37/00

(52) U.S. Cl. 210/767; 210/497.01

(57) ABSTRACT

A filter assembly includes a support cage, an end-cap removably coupled to an end of the support cage, and a removable filter medium substantially enveloping the support cage, the filter medium being removable by removing the end-cap and sliding the filter medium from around the support cage.

### BACKGROUND AND SUMMARY OF THE INVENTION

The present invention relates to filters, and particularly to filters that include a filter medium supported by an underlying support structure.

Conventional filters include a filter assembly having a wire-mesh filter medium mounted on an underlying perforated base pipe support structure. These filter assemblies may be used for water filtration, to filter impurities out of rubber, or for various other fluid filtration processes known to those of ordinary skill in the art. Conventional filter assemblies are manufactured with elements of the assembly permanently connected. For example, in typical filter assemblies, the wire-mesh filter medium is permanently connected to the perforated base pipe. Once the filter medium becomes clogged, other structures that are connected to the filter medium, including the filter support, must be discarded. Moreover, if a portion of the filter medium in a conventional filter assembly becomes clogged, that portion of the filter support radially inwardly from the clog become useless. In other words, fluid cannot flow through a portion of the filter support radially inwardly from a clog in the filter medium.

Frequent disposal of conventional filter assemblies is costly. For example, in the production of rubber for angioplasty balloons, the entire filter assembly is discarded after a batch of rubber has been filtered. Further, it is desirable to maximize the flow of rubber through a filter assembly. A filter assembly which is configured to allow for disposal of the filter medium without disposing of other components of the filter assembly and which maximizes flow rate through the assembly would be welcomed by users of such filter assemblies.

According to the present invention, a filter assembly includes a support cage and a removable filter medium substantially enveloping the support cage and being removable by sliding the filter medium from around the support cage.

In preferred embodiments, the support cage includes a wire spirally wrapped around longitudinally-extending rods. Both the wire and the rods preferably have a triangular-shaped or V-shaped cross-section or profile. The support cage is substantially in the form of a cylindrical tube with a flat edge of the spirally-wrapped triangular-shaped profile wire forming an exterior surface of the cylindrical tube. A threaded end-cap having a retaining lip is welded to one end of the support cage. On the other end of the support cage, a weld-ring with four threaded holes is welded. A top end-cap is screwed to the weld-ring so that a flow-directing rod, formed as part of the top end-cap, is positioned through the weld-ring and into an interior space defined by the cylindrical support cage. The top end-cap, with flow-directing rod, also includes a retaining lip, which generally mirrors the retaining lip of the threaded end-cap. A cylindrical, sintered-laminate filter medium is positioned between, and held by, the two retaining lips, which engage the ends of the filter medium. At each end of the sintered-laminate filter medium, a rubber gasket is positioned in a trough associated with each retaining lip and engages the filter medium to form a seal between the filter medium and the end-caps. In this way, the sintered-laminate jacket surrounds and is supported by the support cage and is longitudinally held in place between the retaining lips on each end.

Additional features and advantages of the invention will become apparent to those skilled in the art upon consideration of the following detailed description of preferred embodiments exemplifying the best mode of carrying out the invention as presently perceived.

### BRIEF DESCRIPTION OF THE DRAWINGS

The detailed description particularly refers to the accompanying figures in which:

FIG. 1 is an exploded perspective view of a filter assembly in accordance with the present invention, showing a top end-cap, a filter medium between two gaskets, a weld-ring, a support cage, and a threaded end-cap;

FIG. 2 is an exploded side view of the filter assembly of FIG. 1, showing the threaded end-cap and weld-ring coupled to opposite ends of the support cage;

FIG. 3 is a cross-sectional view of the filter assembly of FIG. 1 assembled; and

FIG. 4 is a cross-section of a portion of the support cage of the filter assembly of FIG. 1, showing a triangular-shaped profile wire spirally wrapped around triangular-shaped profile rods.

### DETAILED DESCRIPTION OF THE DRAWINGS

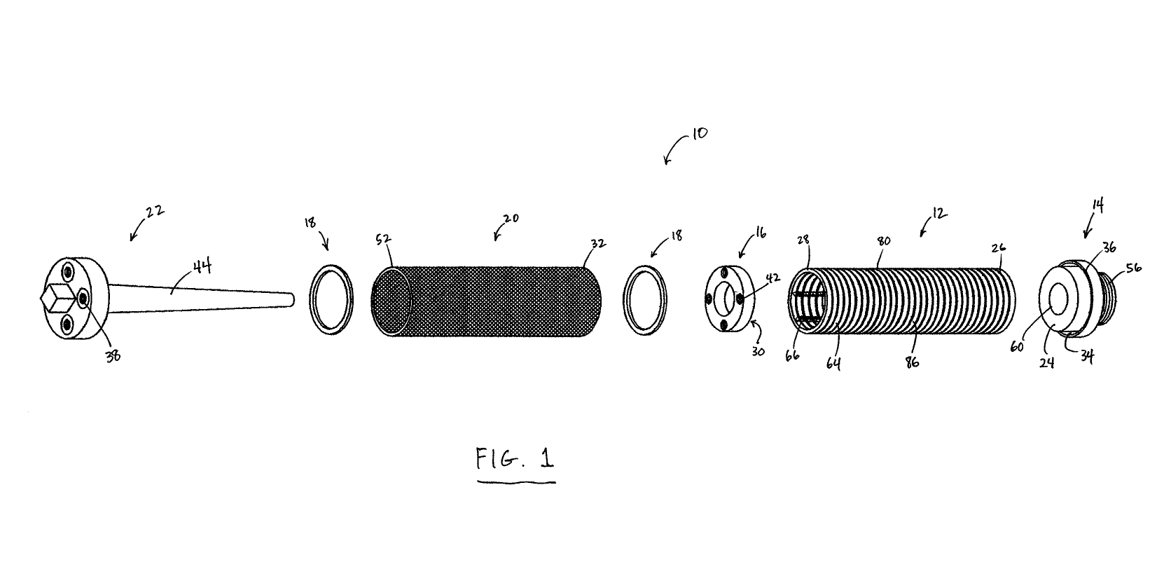

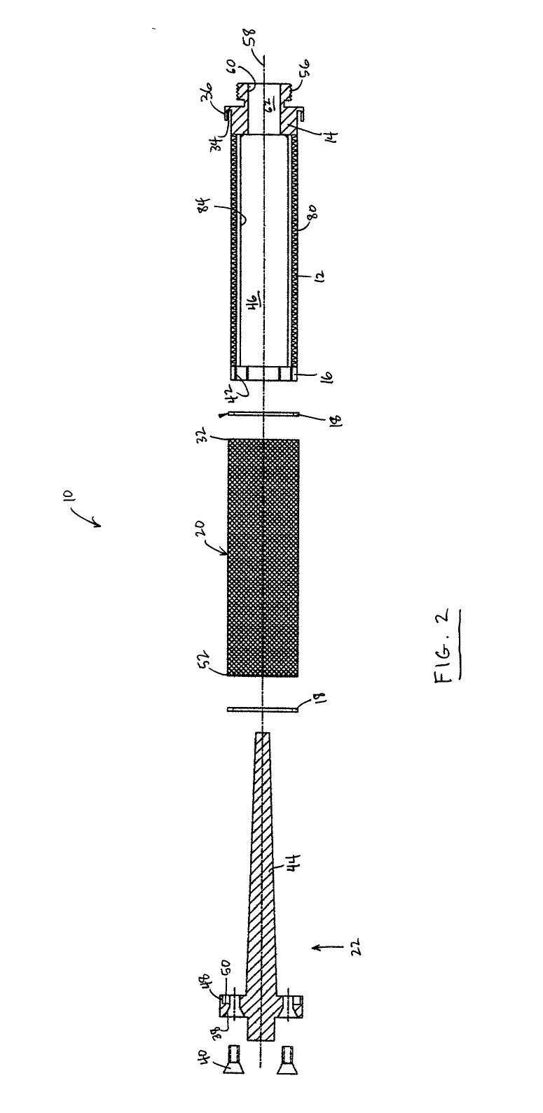

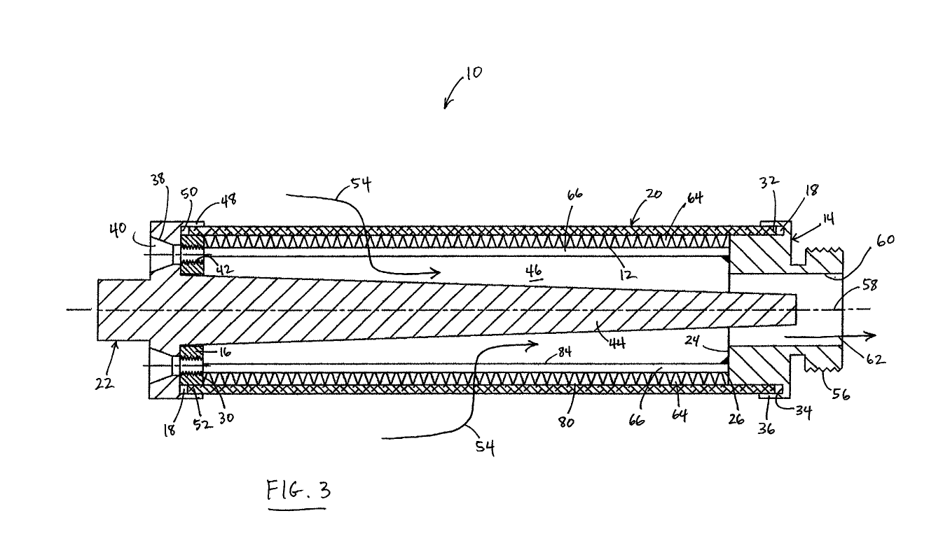

Referring to FIG. 1, a filter assembly 10 in accordance with the present invention includes a support cage 12, a threaded end-cap 14, a weld-ring 16, two rubber gaskets 18, a filter medium 20, and a top end-cap 22. As best seen with reference to FIGS. 1 and 3, a first end 26 of the support cage 12 is welded to an inner face 24 of the threaded end-cap 14 and a second end 28 of the support cage 12 is welded to an inner face 30 of the weld-ring 16. Once the weld-ring 16 and threaded end-cap 14 have been welded to the support cage 12 (see FIG. 2), the filter medium 20 can be slid over the weld-ring 16 and into position around the support cage 12. According to a presently preferred embodiment as illustrated in the accompanying Figures, the support cage 12 and filter medium 20 are cylindrical. However, it will be readily understood by one of ordinary skill in the art that these elements may take on other configurations, including noncylindrical forms.

With the filter medium 20 positioned around the support cage 12 as shown in FIG. 3, a first end 32 of the filter medium 20 nests in a first trough 34 created by a first retaining lip 36 formed as part of the threaded end-cap 14. As best seen in FIG. 1, the first retaining lip 36 extends around the perimeter of the threaded end-cap 14 to create the first trough 34, which also extends around the perimeter of the threaded end-cap 14. One of the rubber gaskets 18 is positioned in the bottom of the first trough 34 and engages the first end 32 of the filter medium 20 to thereby form a seal between the filter medium 20 and the threaded end-cap 14.

Referring to FIG. 3, the top end-cap 22 includes screw-holes 38 through which screws 40 are inserted and screwed into threaded holes 42 formed in the weld-ring 16. In this way, the top end-cap 22 is secured to the weld-ring 16 and a flow-directing rod 44 formed as part of the top end-cap 22 extends into an internal flow chamber 46 defined by the support cage 12. However, it will be readily understood by one of ordinary skill in the art that other methods of coupling the top end-cap 22 to the support cage 12 may be employed, such as threading the top end-cap 22, using a snap fit or compression fit connection, or employing clips or bands, etc. The top end-cap 22 is formed to include a second retaining lip 48, which generally mirrors the first retaining lip 36 formed as part of the threaded end-cap 14. The second retaining lip 48 creates an associated second trough 50 which engages a second end 52 of the filter medium 20 in much the same way the first retaining lip 36 and first trough 34 engage the first end 32 of the filter medium 20. Another rubber gasket 18 is inserted in the second trough 50 and engages the second end 52 of the filter medium 20 to form a seal like that formed by the rubber gasket 18 placed in the first trough 34.

Referring to FIG. 3, with the filter assembly 10 assembled as shown, fluid (for example, very hot rubber in the case of the production of angioplasty balloons) (not shown) is forced at high pressure through the assembly 10 along a flow path generally indicated by arrows 54. The entire filter assembly 10 is screwed into a chamber (not shown) using threads 56 formed as part of the threaded end-cap 14. Fluid is then pumped into the chamber and is forced through the filter medium 20, through the support cage 12, and into the internal flow chamber 46. The fluid flows through the filter medium 20 and support cage 12 in a direction substantially perpendicular to a longitudinal axis 58 defined by the filter assembly 10. However, once in the internal flow chamber 46, the shape of the flow-directing rod 44 reroutes the fluid in a direction substantially parallel to the longitudinal axis 58, as depicted by arrows 54. The fluid then flows through the internal flow chamber 46 and through an opening 60 in the threaded end-cap 14, which defines a passageway 62 out of the filter assembly 10.

Filtering of the fluid takes place as it flows through the filter medium 20. In a preferred embodiment of the invention as shown in FIGS. 1-3, the filter medium 20 comprises a sintered laminate. A sintered laminate is a filter medium produced through a diffusion bonding process. In addition to a sintered laminate, it will be understood by those of ordinary skill in the art that the filter medium 20 may be a sintered fiber, sintered plastic, sintered metal powder, nylon filter, plastic mesh, wire-mesh, porous ceramic tube, or any one of a number of other filter media known to those of ordinary skill in the art.

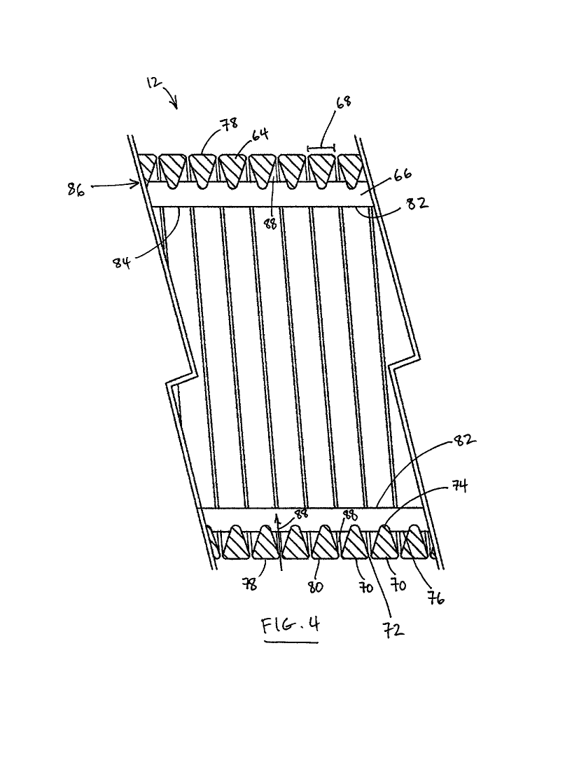

Once the fluid has been filtered through the sintered-laminate filter medium 20, it flows through the support cage 12. In a presently preferred embodiment of the present invention, the support cage 12 is comprised of a wire 64 spirally wound around a series of longitudinally extending rods 66. However, it will be readily understood by those of ordinary skill in the art that other support structures may be used, such as a perforated pipe, etc. As seen in FIG. 4, wire 64 has a substantially triangular-shaped cross-section or profile. The wire 64 is spirally wrapped around rods 66, which also have a substantially triangular-shaped cross-section, as seen in FIG. 1, but either or both of the wire and rods may have alternatively shaped profiles. A profile wire is a wire having a shaped, non-circular cross-section. In a preferred embodiment as illustrated in FIG. 4, the wire 64 and rods 66 each have a generally triangular-shaped profile, each having a width 68 of approximately 0.063 inches, but one of ordinary skill in the art will understand other widths to be suitable as well. As seen in FIG. 4, the wire 64 is spirally wrapped around the rods 66 so that consecutive revolutions 70 of the wire 64 are slightly spaced to form a filter gap 72 there between. In a preferred embodiment as illustrated in FIG. 4, the filter gap 72 is approximately 0.004 inches wide. However, again other widths may be used. The wire 64 is wound around the rods 66 in such a way that a ridge 74 of the wire 64 is slightly embedded into a ridge 76 of each rod 66. In this way, a face 78 opposite the ridge 74 of the wire 64 faces the exterior of the support cage 12 and defines an exterior surface 80 of the support cage 12. Likewise, faces 82 of rods 66 define an interior surface 84 of the support cage 12. The wire 64 and rods 66 define a sidewall 86 between the interior surface 84 and exterior surface 80 and the interior surface 84 defines the internal flow chamber 46. Flow paths 88 through sidewall 86 are formed between consecutive revolutions 70 of wire 64 and flare radially inwardly or, in other words, taper in a radially-outward direction.

The filter medium 20 substantially envelops the exterior surface 80 of the support cage 12. After a fluid (e.g., rubber, water, etc.) has been filtered through the filter medium 20, it passes through the flow paths 88 created in the support cage 12. From there, the fluid flows into the internal flow chamber 46 and out through the passageway 62, as described above. As a fluid (e.g., a batch of rubber) is filtered as just described, the filter medium 20 becomes clogged. According to the present invention, after filtering a fluid, the screws 40 can be unscrewed, thereby releasing the top end-cap 22 from the weld-ring 16. With screws 40 removed, the top end-cap 22 and its flow-directing rod 44 can be slid out of the internal flow chamber 46. In this way, the second retaining lip 48 is backed off of the second end 52 of the filter medium 20. This allows the first end 32 of the filter medium 20 to be backed out of the first retaining lip 36 and slid off of the support cage 12. The clogged filter medium 20 can then be discarded and a new replacement filter medium (not shown) can be inserted in its place to filter another batch of fluid. In this way, only the clogged filter medium 20 need be discarded. The other parts of the filter assembly 10 may be cleaned and can be reused.

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, are within the scope of the present invention. The embodiments described herein are further intended to explain best modes known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

1. A filter assembly, comprising:
a tubular support cage having a perforated sidewall, the sidewall defining an exterior surface and an interior surface which defines an internal flow chamber, the sidewall having at least one opening providing a flow path from outside the support cage to the internal flow chamber;
a first end-cap coupled to a first end of the support cage;
a second end-cap coupled to a second end of the support cage, the second end-cap including a flow-directing rod extending into the flow chamber; and
a removable filter medium surrounding the exterior surface of the support cage sidewall and held between the first and second end-caps.

2. The filter assembly of claim 1, wherein at least one of the first end-cap or second end-cap includes a retaining lip which retains an end of the filter medium.

3. The filter assembly of claim 2, wherein the support cage comprises multiple longitudinally-extending rods and a wire spirally wrapped around the rods.

4. The filter assembly of claim 3, wherein the wire has a substantially triangular-shaped cross-section.

5. The filter assembly of claim 4, wherein at least one rod has a substantially triangular-shaped cross-section which is substantially the same width as the cross-section of the wire.

6. The filter assembly of claim 1, wherein the filter medium comprises a sintered laminate.

7. The filter assembly of claim 6, wherein the tubular support cage is substantially cylindrical.

8. A filter assembly for filtering rubber used in the production of angioplasty balloons, comprising:
an elongated support cage;
a first end-cap coupled to a first end of the support cage and having a retaining lip substantially surrounding the first end-cap;
a second end-cap removably coupled to a second end of the support cage and having a retaining lip substantially surrounding the second end-cap; and
an elongated filter medium substantially surrounding the support cage and retained between the retaining lip of the first end-cap at one end and the retaining lip of the second end-cap at the other end, the filter medium being removable from around the support cage by removing the second end-cap and sliding the filter medium off of the support cage.

9. The filter assembly of claim 8, wherein the support cage is substantially cylindrically tubular and defines an internal flow chamber and the second end-cap includes a flow-directing rod extending into the flow chamber.

10. The filter assembly of claim 9, wherein the support cage comprises multiple longitudinally-extending rods and a wire spirally wrapped around the rods.

11. The filter assembly of claim 10, wherein at least one rod and the wire have a substantially triangular-shaped cross-section.

12. The filter assembly of claim 11, wherein the cross-section of each rod converges to a ridge which runs the length of the rod and which is directed substantially radially outward from a longitudinal axis of the support cage, the cross-section of the spirally-wrapped wire converges to a ridge which runs the length of the wire, and the ridge of the spirally-wrapped wire intersects the ridges of the rods at multiple points throughout the support cage.

13. The filter assembly of claim 9, wherein the filter medium comprises a sintered laminate.

14. The filter assembly of claim 13, wherein the support cage comprises multiple longitudinally-extending rods and a wire spirally wrapped around the rods.

15. A method of filtering rubber for use in the manufacture of angioplasty balloons, the method comprising the steps of:
passing rubber through both a support cage and a first sintered-laminate filter medium substantially enveloping the support cage;
removing an end-cap from an end of the support cage;
sliding the first filter medium off of the support cage;
sliding a second sintered-laminate filter medium onto the support cage, the second filter medium substantially enveloping the support cage; and
replacing the end-cap onto the end of the support cage.

16. The method of claim 15, further comprising the step of discarding the first filter medium after sliding it off of the support cage.

17. The method of claim 16, wherein the support cage and filter medium are substantially cylindrical tubes.

18. The method of claim 17, wherein the support cage defines an internal flow chamber and the end-cap includes a flow-directing rod extending into the internal flow chamber.

19. The method of claim 15, wherein the support cage comprises multiple longitudinally-extending rods arranged substantially in a cylinder and a wire spirally wrapped around the rods.

20. The method of claim 19, wherein at least one rod and the wire have a substantially triangular-shaped cross-section and the cross-section of the at least one rod has substantially the same width as the cross-section of the wire.

21. A filter assembly, comprising:
a support cage;
an end-cap removably coupled to an end of the support cage; and
a removable, sintered-laminate filter medium substantially enveloping the support cage, the filter medium being removable by removing the end-cap and sliding the filter medium from around the support cage.

22. The filter assembly of claim 21, wherein the support cage is tubular and defines an internal flow chamber and the end-cap includes a flow-directing rod, which extends into the flow chamber.

23. The filter assembly of claim 21, wherein the support cage comprises multiple longitudinally-extending rods and a wire wrapped around the rods.

24. The filter assembly of claim 23, wherein the longitudinally-extending rods are arranged in the form of a cylindrical tube and the wire is spirally wrapped around the rods in a series of consecutive revolutions, thereby creating a filter gap between the consecutive revolutions of the wire.

25. The filter assembly of claim 24, wherein the wire has a substantially triangular-shaped cross-section.

26. The filter assembly of claim 24, wherein the filter gap has a width of less than 0.010 inches.

27. The filter assembly of claim 24, wherein the wire has a width of less than 0.010 inches.

28. A filter assembly, comprising:
a support cage comprising multiple longitudinally-extending rods and a wire spirally wrapped around the rods;
an end-cap removably coupled to an end of the support cage; and
a removable filter medium substantially enveloping the support cage, the filter medium being removable by removing the end-cap and sliding the filter medium from around the support cage.

29. The filter assembly of claim 28, wherein the support cage is tubular and defines an internal flow chamber and the end-cap includes a flow-directing rod, which extends into the flow chamber.

30. The filter assembly of claim 28, wherein the longitudinally-extending rods are arranged in the form of a cylindrical tube and the wire is spirally wrapped around the rods in a series of consecutive revolutions, thereby creating a filter gap between the consecutive revolutions of the wire.

31. The filter assembly of claim 30, wherein the wire has a substantially triangular-shaped cross-section.

32. The filter assembly of claim 30, wherein the filter gap has a width of less than 0.010 inches.

33. The filter assembly of claim 30, wherein the wire has a width of less than 0.10 inches.
